(19) United States
(12) Patent Application Publication
(10) Pub. No.: US 2025/0306222 A1
(43) Pub. Date: Oct. 2, 2025

(54) METHOD AND SYSTEM FOR DETERMINING A POSE

(71) Applicant: Carl Zeiss AG, Oberkochen (DE)

(72) Inventors: Carsten Glasenapp, Oberkochen (DE); Ulrich Vogl, Aalen (DE)

(21) Appl. No.: 19/236,734

(22) Filed: Jun. 12, 2025

Related U.S. Application Data
(63) Continuation of application No. PCT/EP2023/085023, filed on Dec. 11, 2023.

(30) Foreign Application Priority Data
Dec. 15, 2022 (DE) 10 2022 133 517.8

(51) Int. Cl. G01T 1/29; G06T 7/00; G06T 7/70

(52) U.S. Cl. CPC G01T 1/2907; G06T 7/0002; G06T 7/70

(57) ABSTRACT

Methods and systems capture and evaluate a plurality of two-dimensional diffraction patterns for the purpose of estimating a pose. The plurality of two-dimensional diffraction patterns are caused by diffraction of coherent radiation with different wavelength components at an element. An evaluation device is configured to determine a pose of the element on the basis of the plurality of two-dimensional diffraction patterns.

### CROSS-REFERENCE TO RELATED APPLICATIONS

This application is a continuation application of international patent application PCT/EP2023/085023, filed Dec. 11, 2023, designating the United States and claiming priority from German application 10 2022 133 517.8, filed Dec. 15, 2022, and the entire content of both applications is incorporated herein by reference.

### TECHNICAL FIELD

The disclosure relates to pose estimation methods and systems. The disclosure relates in particular to contactless pose estimation methods and systems that use electromagnetic radiation, and components to this end.

### BACKGROUND

Pose estimation for elements has numerous applications, for example in manufacturing technology or medical technology. An field of application is the pose estimation for workpieces (that is, estimation of the degrees of translational and rotational freedom of workpieces). This can be performed conventionally using tactile methods or contactless methods.

Techniques of contactless pose estimation for an element require certain compromises. For example, in the case of camera tracking systems with a plurality of cameras or interferometric techniques, there is interplay between achievable accuracy and achievable spatial dynamic range (that is, a detection volume and/or solid angle range). It is challenging to achieve high accuracy over a large detection volume and/or a large solid angle range.

For camera-based detection with one camera, a signature for a deflection in one degree of freedom in general cannot be clearly distinguished from deflections in other degrees of freedom. For example, this may be partially overcome by the use of a plurality of cameras. Incoherently illuminated camera tracking systems are an example in this respect. In addition, a relatively high accuracy is often achievable in two translative coordinates in the case of incoherently illuminated systems, but the resolution for the remaining direction is often much worse.

Coherent illumination may offer improvements in relation to these disadvantages of incoherently illuminated systems. A measurement of the relative phase angle of the wave trains involved also allows a reconstruction of the pose in the depth direction, that is, in the beam direction, with interferometric accuracy.

In addition to the achievable precision in up to six degrees of freedom, the various conventional methods also differ in terms of the absolute accuracy that can be achieved in each case. Typically, intrinsic and extrinsic camera parameters are calibrated by way of a known test standard. In multi-camera systems, an absolute position of the individual cameras can be calibrated from this, and an absolute pose of the target object for the pose estimation can be derived accordingly therefrom. In the case of single-camera systems and pose estimation targets including repetitive grating structures, absolute pose estimation is generally only possible using additional measurement techniques.

Hence the technology still needs improved methods and systems of pose estimation for a target object. In particular, there is a need for systems and methods that offer improvements in view of the achievable accuracy and/or dynamic range in which pose estimation is possible. In particular, there is a need for such systems and methods that allow estimation of an absolute pose (absolute translational position and/or rotational position relative to a reference system) with high accuracy. There is also a need for elements that can be used in such pose estimation methods.

### SUMMARY

According to one aspect, the disclosure relates to a pose estimation system. The system includes at least one detector that is configured to capture a plurality of two-dimensional diffraction patterns caused by diffraction of coherent radiation at an element. The system includes an evaluation device that is configured to estimate a pose of the element on the basis of the plurality of two-dimensional diffraction patterns. In this case, the coherent radiation has different wavelength components, and/or the element includes a diffraction structure that allows a bijective assignment of the plurality of two-dimensional diffraction patterns to exactly one pose.

The use of diffraction makes it possible to increase the solid angle over which the pose estimation is possible. Inherent geometric constraints of reflective techniques are relaxed. The use of coherent radiation with different wavelength components allows ambiguities to be resolved and an absolute pose to be estimated unambiguously. In an alternative to that or in addition, the use of a diffraction structure of the element, which allows the bijective assignment of the plurality of two-dimensional diffraction patterns to exactly one pose, allows ambiguities to be resolved and a unique estimation of an absolute pose to be made possible.

The different wavelength components may be phase stable to one another.

This makes it possible to also use synthetic wavelengths, which are caused by coherent superposition and interference of different wavelength components, in the pose estimation.

The evaluation device may be configured to use a relative phase angle of the different wavelength components for estimating the pose of the element.

The use of the phase information simplifies the unambiguous pose estimation in a desired detection volume and over a desired detection solid angle range.

The at least one detector may include one or more detectors configured for acquiring phase information. The detector configured to acquire the phase information or the detectors configured to acquire the phase information may include one or more interferometers.

The at least one detector may include one or more lensless cameras.

The acquisition of the phase information simplifies the unambiguous pose estimation in a desired detection volume and over a desired detection solid angle range.

The evaluation device may be configured to determine a surface reconstruction of the element and/or a pose estimate for the element by digital holography.

This allows an initial value to be provided, which can subsequently be refined by the evaluation device.

The evaluation device may be configured to determine the surface reconstruction of the element and/or the pose of the element using the diffraction images captured for the plurality of wavelength components.

This allows an initial value to be provided, which can subsequently be refined by the evaluation device.

The system may be configured to allow a variable adjustability of a relative phase angle of the different wavelength components.

This may bring about a further improvement in the resolution of the pose estimation over a high dynamic range.

The evaluation device may be configured to use reference data, which depend on a configuration of a diffraction structure of the element, for the pose estimation. The reference data may contain a configuration specification for a diffraction structure of the element. The reference data may define a geometry of the diffraction structure of the element. For example, the reference data regarding the diffraction structure may be transferred to the evaluation device from a system that is used to manufacture the element.

The reference data may be such that they allow a forward calculation of an expected diffraction pattern at each detector and for each of the wavelength components.

This facilitates the pose estimation without the need for comprehensive reference measurements.

The evaluation device may be configured to carry out a multi-stage evaluation process for the pose estimation, which contains an initial pose estimate and a refinement of the pose estimate on the basis of the plurality of two-dimensional diffraction patterns.

This allows the high resolution, which can be achieved using coherent measurement methods, to be realized in iterations of the iterative process. The initial pose estimate can be used to reduce the computational complexity, for example when expected diffraction patterns are determined by a forward calculation using knowledge of the geometry of the diffraction structure (which may be encoded in the reference data, for example) and are compared with the captured diffraction patterns.

The evaluation device may be configured to use the reference data to refine the pose estimate.

This allows the high resolution, which can be achieved using coherent measurement methods, to be realized in iterations of the iterative process.

The evaluation device may be configured to determine at least one reference diffraction pattern that is expected at the at least one detector from the reference data and the pose estimate and refine the pose estimate on the basis of a comparison of the at least one two-dimensional diffraction pattern with the at least one reference diffraction pattern.

This allows the pose estimation to be implemented with the high resolution of coherent measurement methods without the need for undertaking comprehensive reference measurements for calibration.

The evaluation device may be configured to determine a plurality of expected reference diffraction patterns and use these to refine the pose estimate.

This allows the pose estimation to be implemented with the high resolution of coherent measurement methods without the need for undertaking comprehensive reference measurements for calibration.

The evaluation may include an iterative refinement of the pose estimate.

As a result, the iterative method allows an efficient search in the parameter space of possible poses, in particular in a parameter space of up to 6 dimensions.

The system may further include a radiation source or a radiation source arrangement having a plurality of sources for creating the coherent radiation. Different configurations for creating the coherent radiation are possible. For example, a radiation source may be configured such that it simultaneously outputs a plurality of coherent wavelength components and optionally also creates these. In a further configuration, a plurality of sources of a radiation source arrangement may be configured such that each of them outputs at least one of the coherent wavelengths and components and optionally also creates these. The radiation source or the radiation source arrangement may include at least one laser, a frequency comb and/or an optical parametric oscillator. By using such sources, the various degrees of freedom of the element can be determined with high accuracy. For example, a frequency comb able to output a plurality of wavelength components, each of which is coherent and which are coherent to one another overall, can advantageously be used.

The at least one radiation source or the radiation source arrangement may be arranged stationarily relative to the element. For example, both the radiation source (for example, an end of an optical fiber coupled to a laser or to a frequency comb) and the element may be attached to the same carrier. For example, the carrier may be a workpiece, a tool or a medical instrument whose pose in a detection volume should be estimable over a certain spatial region of rotations.

By using a radiation source or radiation source arrangement arranged stationarily relative to the diffractive element, the creation of the diffraction patterns and their evaluation can be facilitated. In particular, there no longer is the need for updating a beam axis of the coherent radiation in accordance with the current translational position of the diffractive element.

The diffractive element may be arranged movably relative to the at least one radiation source. A tracking mechanism of the system may be configured to update a beam axis of the coherent radiation such that the coherent radiation is incident on the diffractive element.

The at least one detector may include a plurality of channels for capturing the different wavelength components.

As a result, the different wavelength components may be used for the bijective assignment of the plurality of diffraction patterns to exactly one pose.

The at least one detector may be configured for capturing a synthetic wavelength formed by coherent superposition of the different wavelength components.

As a result, the further improvement in the resolution and/or magnification of the dynamic range which is achievable with wavelength components that are phase stable to one another may be used efficiently.

The at least one detector may include a plurality of detectors.

Further improvements in pose estimation may be achieved as a result, for example by virtue of being able to reduce the effects of possible shadowing.

Surface normals of detector surfaces of the plurality of detectors may be offset and/or tilted relative to one another.

Further improvements in pose estimation may be achieved as a result, for example by virtue of being able to reduce the effects of possible shadowing.

The plurality of detectors may be positioned along a surface of a detection volume.

The evaluation device may be configured to computationally determine four, five or six degrees of freedom of the element for the pose estimation.

For refining a pose estimate determined using a further measuring system, the evaluation device may be configured to computationally determine at least one degree of freedom of the element with a higher accuracy than is possible with the further measuring system.

The system may also include the element at which the coherent radiation is diffracted.

The element may be a diffractive element. The element may include a diffraction structure having a planar or volumetric arrangement of diffraction structure elements.

This can facilitate a bijective assignment of the two-dimensional diffraction patterns to exactly one pose.

The diffractive element may be configured such that the two-dimensional diffraction patterns arising at the at least one detector can be uniquely assigned to one pose of the diffractive element in a detection volume.

To this end, for example, the non-periodic volumetric diffraction structure may be defined in a manner depending on the dimensions of the detection volume, a desired solid angle range of resolvable rotations of the element and a detector surface of the at least one detector.

This can ensure that a unique pose estimation in the desired dynamic range is possible for the respective available detector configuration.

The diffractive element may be configured such that it does not create repetitions of the two-dimensional diffraction patterns of the coherent radiation over a predetermined volume and/or over a predetermined solid angle range.

This can ensure that a unique pose estimation in the desired dynamic range is possible for the respective available detector configuration.

The diffractive element may be configured in such a way that it induces a diffraction pattern over a solid angle range of at least 2π, more than 2π, more than 3 π or 4π.

This enables a pose estimation even when the element rotates in a correspondingly large solid angle range.

The diffractive element may include a transparent or translucent material in which a diffraction structure is formed.

This may facilitate the coverage of a relatively large solid angle range.

The diffractive element may include a glass or a quartz material in which the at least one diffraction structure is formed.

A good temperature stability of the measuring technique can be achieved as a result.

The diffractive element may include a material, for example a glass or quartz material with high temperature stability, with a coefficient of thermal expansion (CTE) value of no more than 100 ppb/K, no more than 50 ppb/K, no more than 20 ppb/K or no more than 10 ppb/K at room temperature.

A good temperature stability of the measuring technique can be achieved as a result.

The diffractive element may have a faceted surface, for example a surface with one or more polyhedron portions.

This may facilitate diffraction into a relatively large solid angle range.

The diffraction structure may have a two-or three-dimensional diffraction structure.

This can facilitate a bijective assignment between diffraction patterns and pose. This applies even if only one wavelength component is present, that is, if the coherent radiation is chosen to be monochromatic.

The diffraction structure may have a pseudo-randomly distributed structure, wherein the data used by the evaluation device depend on the pseudo-randomly distributed structure. In other words, scattering centers may be randomly or pseudo-randomly distributed in the configuration process for the element, but the configuration of the diffraction structure is deterministic in the sense that it is known and can be used in the evaluation of the two-dimensional diffraction pattern or the two-dimensional diffraction patterns.

This facilitates a configuration of the element which enables a unique assignment of the pose with high accuracy even over a relatively large dynamic range, for example a relatively large detection volume and/or a relatively large solid angle range of possible rotations of the element.

The system may be an industrial manufacturing system, an industrial measuring system or a medical system.

The system may include a robot or any other actuator, for example a multi-axis robot, which is controllable in order to change a translational position and/or an angular alignment of a workpiece, tool or medical instrument. The pose of the workpiece, tool or medical instrument can be estimated using the system according to the disclosure. In this case, the diffractive element may be arranged on the workpiece, tool or medical instrument or on a movable component of the robot.

The system may include a human-machine interface, via which a result of the pose estimation can be output.

In an alternative to that or in addition, the system may be configured to use a result of the pose estimation to control at least one actuator. The system may be configured in such a way that an industrial manufacturing process, an industrial quality control and/or a medical instrument is influenced by the actuation of the at least one actuator.

According to another aspect of the disclosure, a pose estimation method is provided, the latter including the following steps: capturing a plurality of two-dimensional diffraction patterns using at least one detector, wherein the plurality of two-dimensional diffraction patterns are caused by diffraction of coherent radiation at an element, and estimating a pose of the element on the basis of the plurality of two-dimensional diffraction patterns. The coherent radiation may have wavelength components with different wavelengths. In an alternative to that or in addition, the element may include a diffraction structure that allows a bijective assignment of one or more diffraction patterns created by diffraction at the diffraction structure to exactly one pose.

Additional optional features of the pose estimation method and the effects achieved therewith in each case correspond to the features and effects described with reference to the system.

According to a further aspect of the disclosure, a diffractive element for pose estimation is provided, wherein the diffractive element includes a diffraction structure that allows a bijective assignment of one or more diffraction patterns created by diffraction of coherent radiation at the diffraction structure to exactly one pose.

This enables a high resolution of the pose estimation, including an absolute pose estimation.

The diffractive element may include a transparent or translucent material in which a diffraction structure is formed.

This may facilitate the coverage of a relatively large solid angle range. Shadowing effects can be avoided.

The diffractive element may include a glass or a quartz material in which the at least one diffraction structure is formed.

A good temperature stability of the measuring technique can be achieved as a result.

The diffractive element may include a material, for example a glass or quartz material with high temperature stability, with a CTE value of no more than 100 ppb/K, no more than 50 ppb/K, no more than 20 ppb/K or no more than 10 ppb/K at room temperature.

A good temperature stability of the measuring technique can be achieved as a result.

The diffractive element may have a faceted surface, for example a surface with one or more polyhedron portions.

This may facilitate diffraction into a relatively large solid angle range.

The diffraction structure may have a two-or three-dimensional diffraction structure.

This can facilitate a bijective assignment between diffraction patterns and pose. This applies even if only one wavelength component is present, that is, if the coherent radiation is chosen to be monochromatic.

The diffraction structure may have a pseudo-randomly distributed structure, wherein the data used by the evaluation device depend on the pseudo-randomly distributed structure. In other words, scattering centers may be randomly or pseudo-randomly distributed in the configuration process for the element, but the configuration of the diffraction structure is deterministic in the sense that it is known and can be used in the evaluation of the two-dimensional diffraction pattern or the two-dimensional diffraction patterns.

This facilitates a configuration of the element which enables a unique assignment of the pose with high accuracy even over a relatively large dynamic range, for example a relatively large detection volume and/or a relatively large solid angle range of possible rotations of the element.

According to a further aspect of the disclosure, a device for use when estimating the pose is provided, the device including the diffractive element according to an aspect or embodiment and a radiation source or radiation source arrangement of coherent radiation.

Different configurations of the radiation source or radiation source arrangement for creating the coherent radiation are possible. For example, a radiation source may be configured such that it simultaneously outputs a plurality of coherent wavelength components and optionally also creates these. In a further configuration, a plurality of sources of a radiation source arrangement may be configured such that each of them outputs at least one of the coherent wavelengths and components and optionally also creates these. The radiation source or the radiation source arrangement may include at least one laser, a frequency comb and/or an optical parametric oscillator. By using such sources, the various degrees of freedom of the element can be determined with high accuracy. For example, a frequency comb able to output a plurality of wavelength components, each of which is coherent and which are coherent to one another overall, can advantageously be used.

The at least one radiation source or the radiation source arrangement may be arranged stationarily relative to the element. For example, the device may include a carrier or a holding device on which both the source/source arrangement and the element are arranged stationarily. For example, the carrier may be a workpiece, a tool or a medical instrument whose pose in a detection volume should be estimable over a certain spatial region of rotations.

By using a radiation source or radiation source arrangement arranged stationarily relative to the diffractive element, the creation of the diffraction patterns and their evaluation can be facilitated. In particular, there no longer is the need for updating a beam axis of the coherent radiation in accordance with the current translational position of the diffractive element.

The carrier or the holding device may be made of a material with a low thermal expansion, for example Invar. The carrier or the holding device may be made of a material whose coefficient of linear thermal expansion at 23° C. has a value of 10·10⁻⁶/K or less, 7·10⁻⁶/K or less, 5·10⁻⁶/K or less or 3·10⁻⁶/K or less.

This allows high accuracy of the pose estimation to be achieved with robustness to thermal fluctuations.

According to one aspect, the disclosure relates to an evaluation device for a pose estimation system. The evaluation device includes the following: an interface for receiving a plurality of two-dimensional diffraction patterns caused by diffraction of coherent radiation at an element, and a processing circuit configured to estimate a pose of the element on the basis of the plurality of two-dimensional diffraction patterns.

Additional optional features of this evaluation device and the effects achieved therewith in each case correspond to the optional features described with reference to the pose estimation system.

According to a further aspect of the disclosure, machine-readable command code is provided, which, when executed by a programmable computing unit, carries out the method according to an aspect or embodiment of the disclosure.

According to a further aspect of the disclosure, a storage medium with machine-readable command code stored thereon is provided, the machine-readable command code, when executed by a programmable computing unit, carrying out the method according to an aspect or embodiment of the disclosure.

The methods, systems and system components according to embodiments of the disclosure achieve various effects. An estimation of absolute pose is rendered possible. The estimation of absolute pose may include the determination of up to three translational degrees of freedom and/or up to three rotational degrees of freedom relative to the coordinate system that is defined by the at least one detector. Compared to various conventional methods for estimating absolute pose, the pose estimation can be implemented with a greater accuracy and in a larger dynamic range.

The methods, systems and system components can be used in various sectors. This includes pose estimation in an industrial environment, for example the pose estimation in industrial manufacturing and/or quality control. The methods, systems and system components may also be used in the context of medical devices or medical systems.

### BRIEF DESCRIPTION OF DRAWINGS

The invention will now be described with reference to the drawings wherein:

FIG. 1 shows a pose estimation system according to one embodiment;

FIG. 2 shows the system of FIG. 1 after an optical element was displaced translationally and rotated;

FIG. 3 shows a pose estimation system according to one embodiment;

FIG. 4 shows a pose estimation system according to one embodiment;

FIG. 5 shows a pose estimation system according to one embodiment;

FIG. 6 is a schematic illustration of a diffractive element which can be used in systems and methods according to embodiments;

FIG. 7 is a schematic illustration of a diffractive element which can be used in systems and methods according to embodiments;

FIG. 8 is a schematic illustration of a diffractive element which can be used in systems and methods according to embodiments;

FIG. 9 is a schematic illustration of a diffractive element which can be used in systems and methods according to embodiments;

FIG. 10 is a flowchart of a method according to one embodiment;

FIG. 11 is a flowchart of a method according to one embodiment;

FIG. 12 is a flowchart of a method according to one embodiment;

FIG. 14 is a schematic illustration of an evaluation device which can be used in systems and methods according to embodiments;

FIG. 15 is a schematic illustration of a machine learning model which can be used by the evaluation device according to FIG. 14;

FIGS. 16 and 17 show sources or radiation source arrangements which can be used in the pose estimation systems and methods according to the disclosure;

FIG. 18 is a schematic illustration of a unit which can be used in systems and methods according to embodiments;

FIG. 19 is a schematic illustration of a diffractive element which can be used in systems and methods according to embodiments; and,

FIG. 20 shows a system according to one embodiment.

### DETAILED DESCRIPTION

Embodiments of the disclosure will be described with reference to the figures. In the figures, similar or identical reference signs denote elements with similar or identical configuration and/or function.

While embodiments are described in the context of pose estimation in industrial settings or in medical technology, the systems and methods described here are not limited to these fields of application.

The features of the embodiments can be combined with one another, unless this is expressly precluded in the following description.

Pose estimation methods and systems according to embodiments allow an absolute pose of an element to be estimated. Estimation of an absolute pose is understood here to mean the determination of up to three translational and/or up to three rotational degrees of freedom in a reference system, wherein the element is movable relative to the reference system. For example, the reference system may be defined by one or more detectors that are used in pose estimation for the capture of two-dimensional diffraction patterns.

The captured diffraction patterns may each be speckle patterns.

The estimated pose may be the pose of the element or, derived therefrom, the pose of a rigid part connected to the element, for example a workpiece, tool or surgical instrument.

Pose estimation methods and systems may use two-dimensional diffraction patterns in the far field to perform the pose estimation. Coherent radiation is radiated onto the element in the process. According to the art, a far field of a two-dimensional diffraction pattern caused by the diffraction structure is understood to mean, in particular, a distance between the detector and the diffraction structure of the optical element which allows a computational determination of the two-dimensional diffraction pattern using the Fraunhofer approximation.

The detector or each of the detectors used to capture two-dimensional diffraction patterns for example may have a distance from the element of at least two times the longest wavelength of the coherent radiation, three times the longest wavelength of the coherent radiation, five times the longest wavelength of the coherent radiation or ten times the longest wavelength of the coherent radiation.

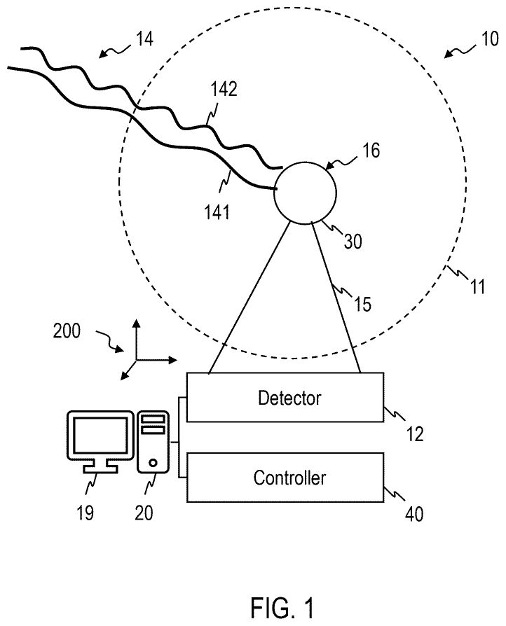

FIG. 1 shows a pose estimation system 10. The system 10 is configured to estimate an absolute pose of an optical element 30 in a detection volume 11. The system 10 may be configured to determine both a translational position and a rotation of the optical element 30 relative to a coordinate system 200 defined by at least one detector 12.

The system 10 includes at least the element 30, one or more detectors 12 and an evaluation device 20.

The element 30 is configured in such a way that the pose can be unambiguously estimated from captured two-dimensional diffraction patterns. In other words, there is a bijection between any possible combination of the captured two-dimensional diffraction patterns and exactly one pose. For this purpose, the element may for example have a planar or volumetric diffraction structure. The planar or volumetric diffraction structure may have a non-periodic configuration, for example random or quasi-random configuration, known to the system 10. It may be formed by techniques such as laser writing or three-dimensional printing. The element 30 may optionally have further structures, in particular a further diffraction structure, in addition to the non-periodic diffraction structure. This further diffraction structure may be periodic and may be used, for example, to determine an initial estimate for the pose, which is then refined by the techniques subsequently described in detail below.

The detector or the plurality of detectors 12 are configured to capture a plurality of two-dimensional diffraction patterns created by diffraction of coherent radiation 14 at the optical element 30. The coherent radiation 14 has wavelength components 141, 142 with different wavelengths. Each of the wavelength components 141, 142 is coherent radiation at one wavelength. The different wavelength components 141, 142 may be phase stable to one another, but this is not mandatory.

The detector or the plurality of detectors 12 are configured to capture the plurality of two-dimensional diffraction patterns in the far field in order to facilitate a computational pose estimation. For this purpose, the detector or the detectors 12 may be arranged around the detection volume 11 at a distance from the optical element 30. The position of each detector 12 may be defined to ensure that one or more two-dimensional diffraction patterns in the far field are captured by the detector 12 for each pose of the optical element 30 in the detection volume 11.

Each detector 12 may include a two-dimensional arrangement of sensor pixels. The sensor pixels may be arranged on a detector surface. Various sensors known in the art may be used.

At least one detector 12 or a plurality of detectors 12 may have a plurality of color channels. The plurality of color channels may correspond to the different wavelengths of the wavelength components 141, 142 but, especially should the different radiation components be phase stable to one another, may also contain at least one color channel that corresponds to a synthetic wavelength created by the coherent superposition of two wavelength components 141, 142 that are phase stable to one another.

For example, should the coherent radiation have a first wavelength component 141 at a first wavelength λ₁ and a second wavelength component 142 at a first wavelength λ₂, the at least one detector 12 may be configured to capture radiation at a wavelength of λ₁·λ₂/|λ₁−λ₂.

The coherent radiation diffracted at the optical element 30 is schematically represented as the radiation 15 incident on detector 12.

The evaluation device 20 is configured to evaluate a plurality of two-dimensional diffraction patterns captured by the detector or the detectors 12. For pose estimation from the two-dimensional diffraction patterns, the evaluation device 20 may also use data that define a configuration of the diffraction structure of the element 30. For example, the data used may originate from a production process of the diffraction structure. The data may define an arrangement of diffraction structure elements in a planar or volumetric diffraction structure, as created by laser writing or 3-D printing, for example.

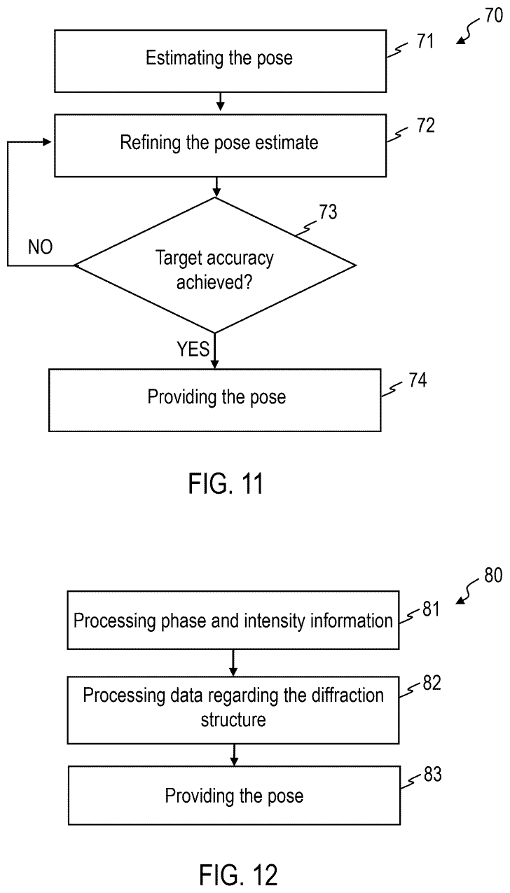

Further features and modes of operation of the evaluation device 20 are described in detail below with reference to FIG. 11 to FIG. 15.

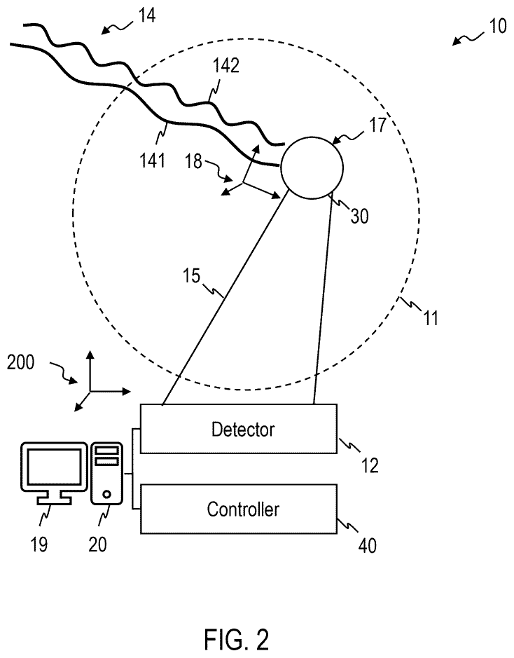

FIG. 2 shows the system 1 after the element 30 has moved translationally to a second position 17 in the coordinate system 200.

The translational movement from the first position 16 to the second position 17 leads to a change in the two-dimensional diffraction patterns. The system 10 may be configured to determine the first position 16 and the second position 17 absolutely in each case, wherein the two-dimensional diffraction patterns captured in each case are evaluated. The second position 17, in particular also a plurality of translational coordinates of the second position, may be determined without needing to use the two-dimensional diffraction patterns captured by the detector or detectors 12 while the element was at the first position 16.

As illustrated schematically in FIG. 2, an object coordinate system 18 of the optical element 30 may rotate relative to that of the coordinate system 200 of the at least one detector. The rotation relative to the coordinate system 200 may be determined by up to three rotational degrees of freedom, which can be specified by three Euler angles, for example. The rotational position is also referred to here as “orientation” in order to allow a simple conceptual distinction from the translational position.

The system 10 may be configured to determine the orientation of the optical element 30 absolutely, wherein the two-dimensional diffraction pattern captured in each case is evaluated. A first orientation of the optical element (FIG. 1) may be determined from at least first two-dimensional diffraction patterns that are captured when the element is in the first orientation. A second orientation of the optical element (FIG. 2) may be determined from second two-dimensional diffraction patterns that are captured when the element is in the second orientation; this second orientation may be determined independently of the first two-dimensional diffraction patterns.

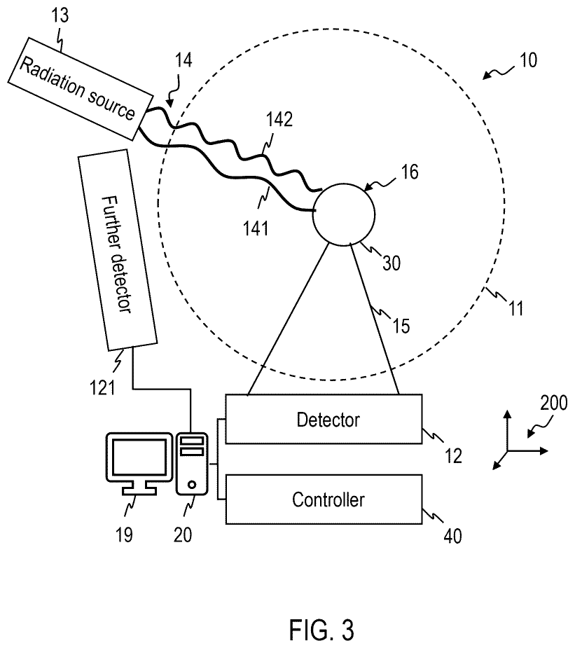

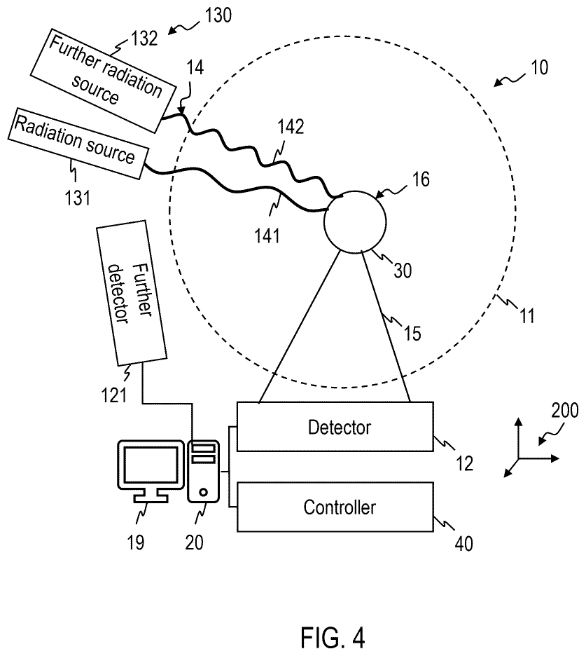

As illustrated in FIGS. 3 and 4, the system may include a radiation source 13 or a radiation source arrangement 130 having a plurality of radiation sources 131, 132 configured to radiate the coherent radiation 14 onto the element 30. The radiation source 13 or the radiation source arrangement 130 may include one or more lasers. The radiation source 13 or the radiation source arrangement 130 may be configured to radiate coherent radiation having a plurality of wavelength components onto the element 30.

The radiation source 13 or the radiation source arrangement 130 may include one or more lasers, each of which is configured to radiate a plurality of wavelength components onto the element 30. The radiation source arrangement 130 may include a plurality of radiation sources 131, 132, for example a plurality of lasers, each of which is configured to radiate exactly one of the wavelength components onto the element 30.

The radiation source 13 may be configured to radiate coherent radiation 14 having the different wavelength components onto the element 30. For example, the radiation source 13 may include a frequency comb generator that is configured to radiate the different wavelength components onto the element 30.

As shown in FIGS. 3 and 4, the system may include a plurality of detectors 12, 121. The detectors 12, 121 may be arranged in a manner distributed around the detection volume 11. Surface normals of detector surfaces (of pixel arrays, for example) of the various detectors 12, 121 may be tilted against one another. The detector surfaces may each be directed in such a way that their surface normals point approximately at a center 17 of the detection volume 11.

The detector 12 or each of one, several or all of the detectors 12, 121 may be configured to acquire phase information. At least one interferometer may be provided for this purpose. A surface reconstruction of the element 30 may be determined from the phase information. In an alternative to that or in addition, the phase information may be used for the bijective assignment between diffraction patterns (containing amplitude and phase information) and poses.

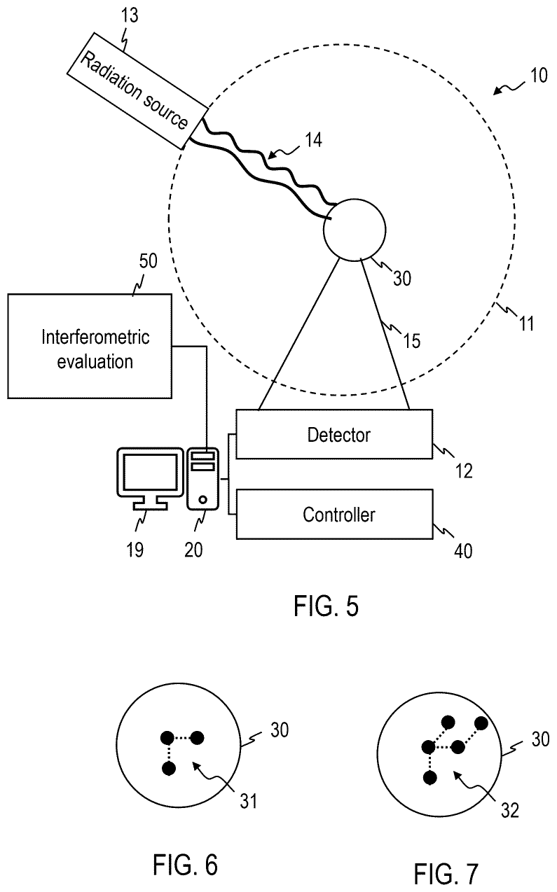

FIG. 5 shows a variant of the system 10 in which phase information is used for a holographic evaluation 50. For this purpose, the evaluation device 20 or a computing unit separate therefrom may be configured to evaluate the phase information for at least one wavelength component 141, 142 and advantageously for a plurality of the wavelength components. The holographic evaluation may be implemented according to known principles of digital holography. The holographic evaluation may be used as a starting point for the more accurate estimation of the pose based on the plurality of diffraction patterns.

As illustrated in FIGS. 1 and 5, the system 10 may include one or more components that make further use of the pose determined by the evaluation device 20. In FIGS. 1 and 5, a human-machine interface 19 and a controller 40 are depicted schematically, and these can receive and represent the estimated pose from the evaluation device 20 or use the pose for a control operation. The controller 40 may be a controller of at least one actuator from a system of industrial manufacturing or quality control or a medical system.

The evaluation device 20 may be configured to output the determined pose to the human-machine interface 19, for example in order to represent the determined pose visually.

The evaluation device 20 may be configured to output the determined pose to the controller 40 in order to enable control of at least one actuator in accordance with a control loop.

The evaluation device 20 may include a network interface and may be configured to transmit the determined pose via a local network or a work traffic network. For example, this may be done to document the poses and/or monitor the system 10 from a remote position.

The pose estimation system according to the disclosure and the pose estimation method carried out by the system achieve various advantages over conventional methods that make use of coherent radiation. One such conventional method is the so-called speckle localization, in which a partially reflective object is illuminated with coherent radiation, and the resultant interference pattern is compared with a reference measurement. The geometry of the partially reflective surface from speckle localization is generally unknown. Then again, the method requires reference measurements. The partially reflective surface from speckle localization also restricts the solid angle over which the pose can be estimated. In addition, on the detector side the speckle localization has the restriction that for a correlative reconstruction of the change in pose, the characteristic interference pattern from the reference measurement may only be displaced by no more than the field of view of the camera, or complex additional reference measurements are required in the alternative.

The pose estimation system and method according to the disclosure, on the other hand, allow estimation of the absolute pose without necessarily requiring reference measurements. The high resolution of coherent measurement methods is maintained in the process.

The pose estimation techniques according to the disclosure have, inter alia, the effect that the accuracy of a coherent measurement method is maintained, but a greater solid angle coverage is made possible.

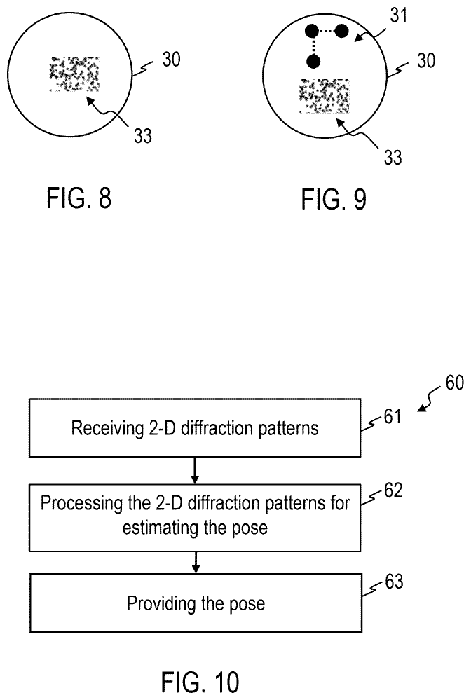

FIGS. 6 to 9 show schematic configurations of the element 30. The element 30 includes a diffraction structure 31 with a planar arrangement of diffraction structure elements (FIG. 6) and/or a diffraction structure 32, 33 with a volumetric arrangement of diffraction structure elements (FIGS. 7, 8 and 9). The more complex configuration of the diffraction structure in comparison with one-dimensional arrangements facilitates an easier bijective assignment of poses and diffraction patterns.

The techniques according to the disclosure also allow definition of a configuration specification and relevant manufacturing parameters for the element 30 such that the desired pose estimation in the dynamic range is possible. The techniques according to the disclosure also allow a measurement rule for transferring an accuracy, which is embodied by the element 30, to the coordinate system 200 of the detector and, overall, to the pose estimation (in up to 6 degrees of freedom or 6 dimensions of the pose space) of the optical element 30.

The element 30 may be structured such that diffraction patterns are created at the detector 12 or detectors 12, 121 under coherent illumination in the far field, and these diffraction patterns allow a bijective assignment of diffraction patterns and the pose of the element 30.

The diffraction structures 32, 33 may include a non-periodic optical grating or another non-periodic volumetric diffraction structure. A periodic grating or any other periodic diffraction structure under coherent illumination has the property that a local interference pattern in a detector plane cannot be uniquely assigned to one pose. This disadvantage can be overcome with the non-periodic grating or any other non-periodic planar or volumetric diffraction structure. In order to determine a suitable configuration for the non-periodic planar or volumetric diffraction structure, a required information content of the diffraction structure can be estimated as follows: A surface of the detection volume 11 can be divided into portions that each have the size of a detector surface of one of the detectors 12, 121. Each of these portions may be assigned a unique, spatially discrete “target” pattern. The different color channels can be taken into account in the process, for example by virtue of assigning a target pattern to each of the color channels. In this context, a useful reference parameter is the pixel size of the detector used. From these initial target diffraction patterns, a reciprocal distribution which corresponds to the required grating volume of the coherently illuminated optical element 30 can be calculated using a discrete Fourier transform. A minimum creatable structure size (which may depend on a pixel dimension of the detector 12, for example) and a desired maximum size of the optical element 30, into which the diffraction structure is introduced, can be used as boundary conditions. Additional boundary conditions can be taken into account when determining the non-periodic planar or volumetric diffraction structure.

The diffraction structure determined as described above, at which the coherent radiation is scattered, defines a producible diffractive element. For the diffraction structure, both the far-field diffraction pattern and the diffraction structure elements of the diffractive element may be arranged quasi-randomly. Nevertheless, the diffraction structure is known and fully computable. This represents another difference to speckle localization, in which the geometry of the partially reflective surface is generally unknown.

For the manufacture of such a diffractive element 30, this allows a targeted construction and verification of the spatial structure of the diffractive element 30. For example, microscopic methods can be used for this purpose. In an alternative to that or in addition, verification of the two-dimensional diffraction patterns in one or more detector levels is rendered possible.

A technical advantage of this approach is that one or a few detectors can be used to determine poses that can cover a large solid angle, optionally even the full solid angle range. For this purpose, the evaluation device 20 can compare the captured two-dimensional diffraction pattern or the captured two-dimensional diffraction patterns with calculated reference diffraction patterns of the element 30. Since the diffraction structure has been specifically produced and/or data defining the diffraction structure can be available to the evaluation device 20, the reference diffraction patterns can be calculated by forward propagation.

Another technical advantage of the technique according to embodiments is that the diffraction structure 31, 32, 33 can be realized in materials such as glasses or quartz materials with a low coefficient of thermal expansion. This ensures improved insensitivity to temperature changes. Known glasses with low thermal expansion can be used. For example, it is possible to use glasses or quartz materials that have a coefficient of thermal expansion (CTE) value of no more than 100 ppb/K, no more than 50 ppb/K, no more than 20 ppb/K, or no more than 10 ppb/K at room temperature (23° C.). Thus, a diffractive element 30 in the order of 1 cm can achieve an accuracy of the measurement standard of <1 nm within a temperature band of 1 K. Projected on a detection plane of the detector 12 or detectors 12, a lateral accuracy of the pose of <1 μm can be achieved.

The element 30 may be configured such that there are diffraction images in a solid angle range of at least 2 π, at least 3 π or the full solid angle range of 4 π. Shadowing may be accepted.

As will still be described in detail below, some requirements on the element 30 and in particular on the non-periodic volumetric diffraction structure 30 may be relaxed.

For example, it is not mandatory for two-dimensional diffraction patterns uniquely linked to a pose to be formed in the various color channels on a detection surface of a detector 12 over the entire surface of the detection volume 11. Ambiguities may be accepted, wherein these may be resolved, for example, using a redundant measuring system.

In addition to the non-periodic planar or volumetric diffraction structure 31, 32, 33, the element 30 may include at least one further diffraction structure, for example a periodic grating, which is used for the resolution of any ambiguities and/or for determining an initial estimate for the pose. The different diffraction structures may differ in terms of a mean distance from structure elements.

Due to the use of coherent radiation having wavelength components with at least two different wavelengths, the techniques disclosed herein may be carried out independently for a plurality of color channels. This relaxes the diffraction structure requirements. A much simpler diffraction structure can be used, as the combination of diffraction patterns from different color channels can be used for the pose estimation. If the radiation components with different wavelengths are phase stable to one another, synthetic wavelengths that further increase the accuracy and/or increase the dynamic range may moreover result from interference.

It is not necessary to configure the diffractive element 30 in such a way that it can radiate diffraction patterns over the entire solid angle range of 4 π. For example, radiation into a smaller solid angle range, for example into a half-space, may be sufficient for numerous applications. In an alternative to that, a plurality of diffractive elements 30 may be combined on a carrier, for example on different side surfaces of an industrial or medical tool, wherein each of the diffractive elements 30 radiates into a solid angle range that is smaller than the solid angle range of 4 It. However, by using the plurality of diffractive elements 30, it may nevertheless be possible to estimate a pose of the carrier over the entire solid angle range.

The functioning of the evaluation device 20 for systems and methods according to embodiments is described in more detail below.

FIG. 10 is a flowchart of a method 60 according to one embodiment. The method 60 may be carried out automatically by the evaluation device 20.

At 61, the evaluation device 20 receives a plurality of two-dimensional diffraction patterns. The plurality of two-dimensional diffraction patterns are captured by at least one detector 12 in a plurality of color channels and are the result of a diffraction of coherent radiation at a diffraction structure of the element 30.

At 62, the two-dimensional diffraction patterns are processed to estimate a pose of element 30. Data that defines the configuration of the diffraction structure may be used for the pose estimation. For example, such data may be available from the manufacturing process of the diffraction structure of the element 30.

At 63, the estimated pose is provided. This may include an output via a human-machine interface 19 or the provision of the pose to at least one controller 40.

FIG. 11 is a flowchart of a method 70 according to one embodiment. The method 70 may be carried out automatically by the evaluation device 20.

At 71, the pose is estimated. The pose can be estimated by using phase information of the diffracted wavelength components. The pose estimate can be determined using digital holographic interferometry. The pose estimate can also be determined from actuating signals of an actuator chain, which move the element 30 in the detection volume 11.

At 72, the pose estimate is refined. This can be done in various ways. For example, with knowledge of the diffraction structure, it is possible to carry out a forward calculation which determines the diffraction patterns expected in each of the plurality of color channels for one or more possible candidate poses in the vicinity of the pose estimate.

At 73, it is possible to check whether a desired target accuracy has been achieved. The check may include a determination of an error measure that quantifies a difference between the diffraction patterns captured in the different color channels and the diffraction patterns determined for a candidate pose by calculation. Any appropriate difference metric for images may be used to quantify the difference.

If the desired target accuracy is not yet achieved, the method can return to step 72.

Otherwise, the estimated pose can be provided at step 74 as explained with reference to step 73.

In addition to the non-periodic volumetric diffraction structure, the diffractive element 30 may include further features that can facilitate the pose estimation or be used for the pose estimation.

FIG. 12 is a flowchart of a method 80 according to one embodiment. The method 80 may be carried out automatically by the evaluation device 20.

At 81, the evaluation device 20 processes phase and intensity information from two-dimensional diffraction patterns. The processing may include a digital holographic reconstruction of a surface of the element 30. The processing may include a pose estimate for the element 30.

At 82, the two-dimensional diffraction patterns are further processed using data relating to the configuration of the diffraction structure of the element 30. These data may define the geometry of the diffraction structure of the element 30.

At 83, the estimated pose is provided. This may include an output via a human-machine interface 19 or the provision of the pose to at least one controller 40.

FIG. 13 is a flowchart of a method 90 according to one embodiment. The method 90 may be carried out automatically by the system 10.

At 91, a plurality of diffraction patterns created by diffraction of coherent radiation with at least two different wavelengths are captured.

At 92, a digital holographic reconstruction of a surface of the element 30 is implemented, as is an initial pose estimate. For this purpose, the evaluation device 20 processes phase and intensity information from the two-dimensional diffraction patterns.

At 93, a plurality of reference diffraction patterns are calculated using data relating to the configuration of the diffraction structure of the element 30. The corresponding forward calculation can be implemented with little computational effort. The plurality of reference diffraction patterns are calculated for different wavelength components.

At 94, the pose is refined. For this purpose, a distance measure for an image comparison can be used in order to determine for which pose the reference diffraction patterns, determined by calculation, in the different color channels are most similar to the actually captured diffraction patterns, that is, for which the distance measure is as small as possible.

At 95, the estimated pose is provided. This may include an output via a human-machine interface 19 or the provision of the pose to at least one controller 40.

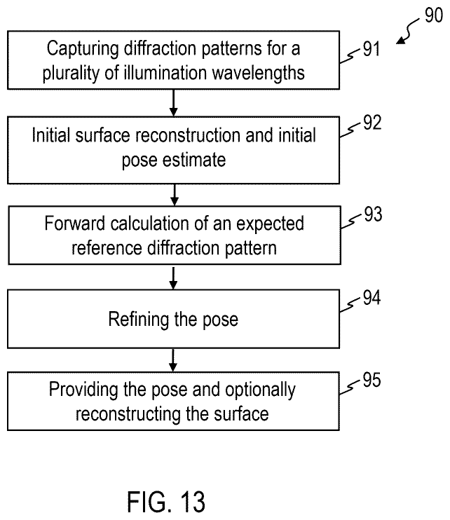

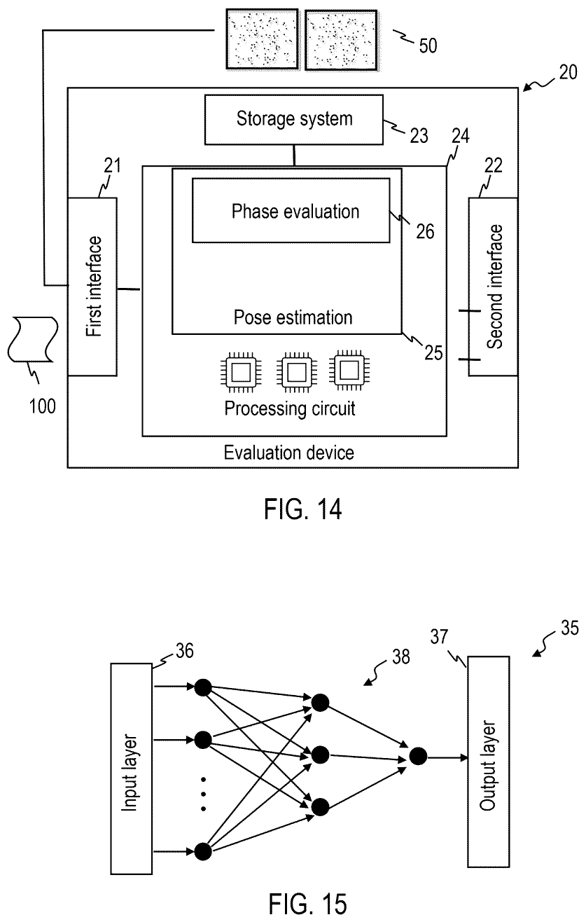

FIG. 14 shows a block diagram representation of an evaluation device 20, which can be used in the system 10 and the methods according to embodiments.

The evaluation device 20 includes at least one first interface 21, via which a plurality of two-dimensional diffraction patterns 50 can be received. The at least one first interface 21 can be communicatively connected to the detector 12 or the detectors 12, either directly or via a data network, for example a wireless or wired local network. Via the at least one first interface 21, the evaluation device 20 is also capable of receiving data 100 that depend on the diffraction structure of the element 30. For example, these data 100 may define the geometry of the diffraction structure as defined in the manufacture of the optical element 30 and inscribed in the element 30. The data 100 may include a configuration file, for example in the form of an XML file, for the manufacture of the optical element 30, with the file being used in the manufacturing process.

The evaluation device 20 includes a processing circuit 24. The processing circuit 24 is configured to process the two-dimensional diffraction patterns 50 for the pose estimation. Optionally, it may process the data 100, which depend on the configuration of the diffraction structure, by calculation. This allows the pose in the detection volume 11 to be estimated.

A pose estimation 25, which is carried out by the processing circuit 24, may include a processing 26 of phase information acquired from the diffraction patterns. For example, a digital holographic reconstruction can be performed and/or both amplitude and phase information can be compared in order to match the actually captured diffraction patterns to computationally determined reference diffraction patterns.

Regardless of whether phase information is used in addition to the amplitude information, reference diffraction patterns determined by calculation from the data 100 for a hypothetical pose of the optical element 30 may be matched to the captured two-dimensional diffraction pattern 50 for the pose estimation. The processing circuit 24 can determine reference diffraction patterns for a plurality of candidate poses and each of the plurality of wavelengths of the coherent radiation by calculation in order to match these in each case to the captured two-dimensional diffraction patterns 50.

Results of the pose estimation 25 may be stored in a storage system 23 of the evaluation device 20 for further use and may be retrieved from there when necessary by the processing circuit 24.

The processing circuit 24 may include one or more integrated circuits to perform the required processing of the two-dimensional diffraction patterns. The one or more integrated circuits may for example include any desired one or any desired combination of the following circuits or circuit components: an application-specific integrated circuit (ASIC), a field-programmable gate array (FPGA), a processor, a controller, one or more quantum gates, a circuit for quantum information processing.

A result of the pose estimation can be output via the at least one first interface 21 or via a second interface 22, differing therefrom, of the evaluation device 20. For example, the result can be output to a human-machine interface or a controller of an industrial or medical system.

The evaluation device 20 can make use of at least one trained machine learning model 35 in order to carry out the pose estimation.

FIG. 15 is a schematic illustration of a machine learning model 35 which can be executed by the evaluation device 20. The machine learning model 35 includes an input layer 36, a plurality of hidden layers 38 and an output layer 37.

The input layer 36 may be configured to receive pixel values of the diffraction patterns captured by the at least one detector. The output layer 37 may be configured to output information about the pose.

In a further configuration, the input layer 36 may be configured to receive both pixel values of the diffraction patterns captured by the at least one detector and reference pixel values determined by calculation, wherein the reference pixel values are determined by calculation from the data 100 regarding the diffraction structure 31. The output layer 37 can then output a probability value indicating whether the captured two-dimensional diffraction patterns correspond to the same pose for which the reference pixel values have been determined by calculation.

A technical advantage of the techniques described here is that labeled data required for training the machine learning model 35 can be determined by calculation in large numbers from the data 100 regarding the diffraction structure. For example, a two-dimensional reference diffraction pattern expected at the detector 12 or the detectors 12, 121 for the corresponding pose can be determined by calculation by forward propagation methods for each of a multiplicity of possible poses of the element 30 in the detection volume 11. This reference diffraction pattern determined by calculation can then be labeled with the known pose for which forward propagation was performed. During training, which may make use of known techniques such as gradient-based techniques, the machine learning model 35 may be trained to the effect of assigning the correct pose to each reference diffraction pattern, by setting the adjustable parameters of the machine learning model 35.

More complex techniques may be used to realize the trained machine learning model 35. For example, generative adversarial networks (GANs) may be used to form and train the machine learning model 35.

The use of a machine learning model is optional. The evaluation device 20 can solve an inverse problem of reconstruction from the momentum space to the position space for estimating the pose in different ways.

For example, the evaluation device 20 may be configured to determine the expected diffraction patterns for the plurality of color channels by calculation for each desired pose. A comparison with the captured two-dimensional diffraction patterns can then be made. The expected diffraction patterns, which are also referred to as reference diffraction patterns, can be stored in the evaluation device 20 or a separate storage system in order to keep latencies in the pose estimation as low as possible.

In an alternative to that or in addition, the evaluation device 20 may be configured to use approximate methods. In this case, an initial estimate for the pose, which need not depend on the diffraction pattern of the diffraction structure, can be refined further. The initial estimate may be received from an additional measuring system having coarser resolution or from a controller of an actuator chain.

In an alternative to that or in addition, the evaluation device 20 may be configured to perform an iterative procedure for estimating the pose. An estimate for the pose can be refined more and more.

The aforementioned techniques may also be combined with one another.

The radiation source 13 or radiation source arrangement 130 creates coherent radiation having a plurality of wavelengths. The radiation source 13, 130 is sufficiently frequency-stabilized in order to allow a well-defined phase angle of the diffraction patterns over a relevant measurement period in which the diffraction patterns are captured.

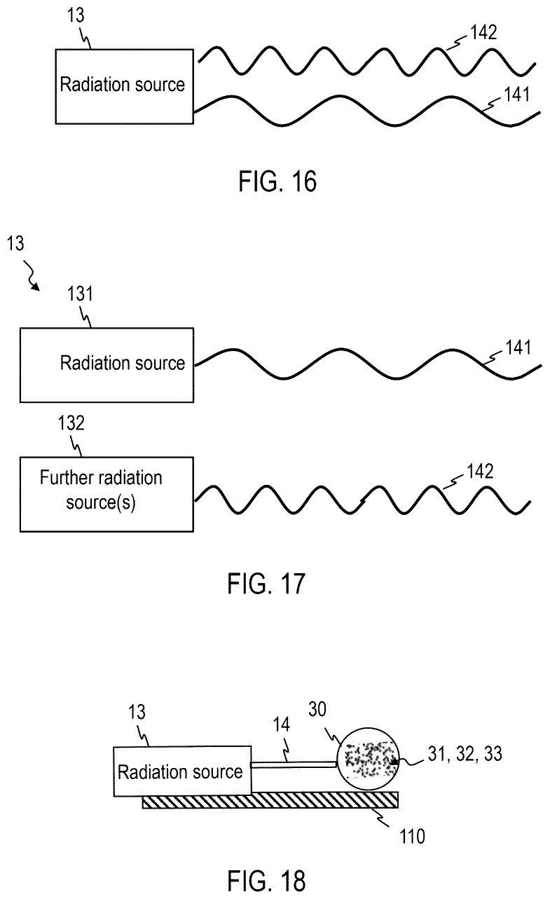

FIG. 16 shows a configuration of a radiation source 13 which outputs wavelength components 141, 142 at different wavelengths. Color demultiplexing may be used to capture the diffraction patterns at the plurality of wavelengths. As a result, an additional degree of freedom is used in detection. The diffraction patterns may be evaluated for different color channels of the detector. This can be done as described above. A computational determination of expected diffraction patterns from the data 100, which can define the configuration of the diffraction structure, can be performed separately for the different wavelengths.

The different wavelength components 141, 142 may be phase stable to one another. This additionally allows the use of synthetic wavelengths, which may be created by interference between the various wavelength components 141, 142. Similar to digital holography, this can achieve good precision.

The different wavelength components 141, 142 may be output by the same physical unit. For example, the radiation source 13 may include a frequency comb generator that outputs the wavelength components 141, 142.

As shown in FIG. 17, the system may also include a radiation source arrangement 130 having a plurality of physically separate radiation sources 131, 132. For example, a first radiation source 131 may be provided, which outputs a wavelength component 141 at a first wavelength, and also at least one further radiation source 132, which outputs a wavelength component 142 at the second wavelength.

The systems and methods described in detail can be used for the pose estimation in industrial manufacturing plants and/or quality control systems or in medical systems. The estimated pose can be supplied to a controller 40, which actuates at least one actuator on the basis of the estimated pose.

FIG. 17 is a schematic illustration of a system 10 including a robot arm 41. Instead of a robot arm 41, other mechanisms may also be used to move a target object 42 in a working region.

The pose estimated by the evaluation device 20 can be supplied to a controller 40, which is configured to create at least one control signal for an actuator (for example of the robot arm) on the basis of the estimated pose. In this way, the pose of a target object 42, for example a workpiece, tool or surgical instrument, can be checked and, if necessary, adjusted.

As shown in FIG. 17, the diffractive element 30 can be securely connected to the target object 42 or formed integrally with the latter. Since the diffractive element 30 is typically arranged offset from a predefined point of the target object 42 (for example, the volume center point or a tool tip), it is often necessary to determine all three translational and all three rotational coordinates of the diffractive element 30 in order to determine the location of the predefined point of the target object 42 in the detection volume.

Pose estimation systems and methods use an element 30, which is configured in a purposeful manner. The diffraction structure may be formed in such a way that it allows a unique assignment to any desired poses in the detection volume on the basis of at least one diffraction pattern should data defining the configuration of the non-periodic volumetric diffraction structure be available for the evaluation. These data may be provided during the production of the diffractive element 30 for use by the pose estimation system or method.

FIG. 18 shows a unit with an element 30, which can be used in the systems and methods according to embodiments.

In this case, a radiation source 13 or radiation source arrangement is optionally securely connected to the element 30 via a mechanical coupling element 110. For example, the coupling element may consist of a material such as Invar or another material with low thermal expansion, for example comparable to or less than that of Invar. The coupling element 110 may be a carrier or a holding device. The coupling element may be made of a material whose coefficient of linear thermal expansion at 23° C. has a value of 10·10⁻⁶/K or less, 7·10⁻⁶/K or less, 5·10⁻⁶/K or less or 3·10⁻⁶/K or less.

The evaluation of the diffraction patterns can be simplified by the secure coupling.

The element 30 may have different surface shapes and geometries. For example, the element 30 may have a geometry that contributes to a radiation of diffraction patterns over a desired solid angle range. For this purpose, the element 30 may for example be configured in such a way that it has a faceted surface. The element 30 may have a surface containing polyhedron-shaped regions. The faceted surface may have polyhedron structures without symmetries or statistical triangular shapes.

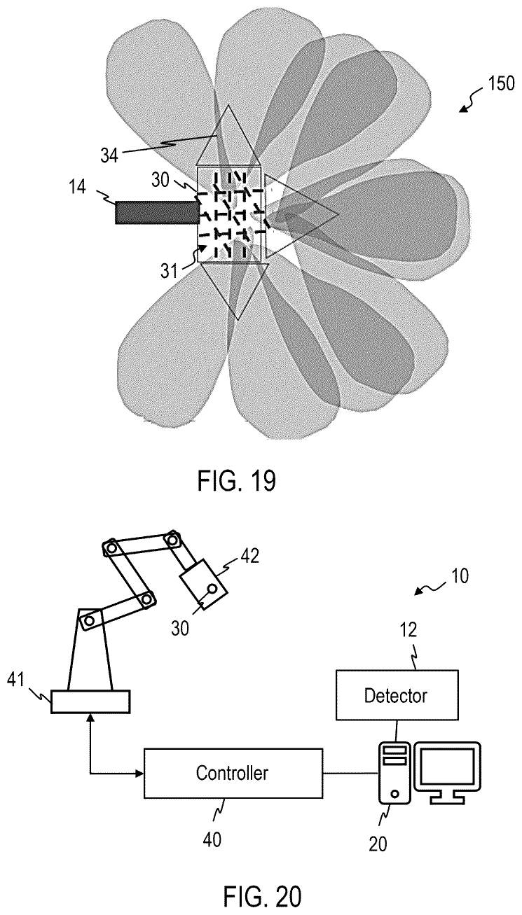

FIG. 19 is a schematic illustration of an element 30 that is produced (in particular formed) in such a way that its surface has polyhedron-shaped regions 34. Thus, it is possible to achieve a characteristic in which diffraction patterns are radiated over a relatively large solid angle range 150.

The systems and methods described in detail can be used for the pose estimation in industrial manufacturing plants and/or quality control systems or in medical systems. The estimated pose can be supplied to a controller 40, which actuates at least one actuator on the basis of the estimated pose.

FIG. 20 is a schematic illustration of a system 10 including a robot arm 41. Instead of a robot arm 41, other actuators or actuator chains may also be used to move a target object 42 in a working region.

The pose estimated by the evaluation device 20 can be supplied to a controller 40, which is configured to create at least one control signal for an actuator (for example of the robot arm) on the basis of the estimated pose. In this way, the pose of a target object 42, for example a workpiece, tool or surgical instrument, can be checked and, if necessary, adjusted.

As shown in FIG. 20, the element 30 can be securely connected to the target object 42 or formed integrally with the latter. Since the diffractive element 30 is typically arranged offset from a predefined point of the target object 42 (for example, the volume center point or a tool tip), it is often necessary to determine all three translational and all three rotational coordinates of the diffractive element 30 in order to determine the location of the predefined point of the target object 42 in the detection volume.

As described with reference to the figures, pose estimation systems and methods use an element that includes a diffraction structure. The diffraction structure is configured such that the diffraction patterns captured for the different wavelengths are bijectively assigned to a pose in the detection volume. The diffraction structure is advantageously known and follows a reproducible configuration rule. Herein lies a difference to diffractive structures that use random interference at two-dimensional surfaces or three-dimensional structures.

The diffraction image created by the element may cover a solid angle of at least 2 π, at least 3 π or 4 π. Due to the configuration of the diffractive element and its application, shadowing may be accepted.

The diffraction structure may be configured on the basis of the configuration of the system 10, in particular on the basis of a size of the detection volume 10 and on the basis of a detector surface and/or pixel size and/or number of color channels of the at least one detector 12.

A calibration may be performed in view of the configuration of the element 30 and/or extrinsic camera parameters of the detector 12 or the detectors 12, 121.

The intensity distribution resulting from the coherent illumination of the diffraction structure 31 at the different wavelengths can be calculated in the detection volume. For this purpose, a Gerchberg-Saxton method, for example, or another technique may be used, which takes into account the angular ranges over which an irradiation by the coherent radiation and/or a detection is possible.

The diffraction patterns can be captured by at least one detector 12. A plurality of detectors 12 may be used in order to cover all degrees of freedom, in particular all three translational and all three rotational degrees of freedom.

The systems and methods can be used not only to estimate the pose of the diffractive element but also to determine higher moments. For example, the systems and methods can also be used to determine translational and/or rotational speeds and/or accelerations. These can also be output via the human-machine interface 19 or provided to the controller 40.

The systems and methods can use an estimate of the pose and refine that estimate. The estimate can be determined using digital interferometric holography. In an alternative to that or in addition, the estimate may be derived from a kinematic chain of actuators with which the evaluation device 20 can be in communication connection and which changes the pose of the diffractive element 30.

The diffractive element 30 may be produced by laser writing or other techniques, such as 3-D printing. Such techniques allow the formation of a non-periodic volumetric diffraction structure which has a dimension of less than 5 cm, less than 3 cm, less than 2 cm, less than 1 cm, less than 5 mm, less than 3 mm, less than 1 mm, less than 0.5 mm, less than 0.3 mm or less than 0.1 mm, but which, using conventional detector surfaces and pixel sizes, may enable a bijection between pose and diffraction patterns over a detection volume with a radius of at least 1 cm, at least 3 cm, at least 5 cm, at least 10 cm, at least 30 cm, at least 50 cm, at least 1 m, at least 2 m, at least 3 m or more.

While embodiments have been described with reference to the figures, modifications can be realized in further embodiments. For example, the following modifications can be used alternatively or cumulatively:
less than three rotational coordinates and/or less than three translational coordinates can be determined. For example, should high accuracy only be of interest for the angular degrees of freedom, the coherent illumination may be positioned such that the diffractive element moves relative thereto. A rough tracking of the coherent radiation is then sufficient;
the requirement of the bijective assignment between pose and diffraction pattern can be relaxed if at least one auxiliary measuring system 90 is used to estimate the pose with a lower resolution;
it is possible but not mandatory for the full solid angle to be covered by the diffraction image. For example, a half-space or a smaller angular range may be sufficient to perform a desired pose estimation for the respective application. This allows a reduction in the illuminated volume of the diffractive element.

While a description of embodiments which can be used in systems of industrial manufacturing or quality control or medical technology was given, the disclosed techniques can also be used in other areas of application.

The present disclosure also encompasses embodiments with any combination of features that are specified or shown in relation to different embodiments. It also encompasses individual features in the figures, even if they are shown there in connection with other features and/or not mentioned above or below. The alternatives of embodiments described in the figures and the description and individual alternatives of their characteristics may also be excluded from the subject matter of the disclosure or from the disclosed subject matter.

A machine-readable command code which may be carried out by a programmable circuit for the execution of methods according to embodiments may be stored and/or distributed on a suitable medium, such as on an optical storage medium or a solid-state medium, which is provided together with or as part of other hardware. The command code may also be distributed in other forms, for example in the form of a modulated data signal sequence.

Embodiments of the disclosure make available improved techniques for pose estimation, which allow the estimation of an absolute pose (in particular of up to six degrees of freedom) with interferometric accuracy.

It is understood that the foregoing description is that of the preferred embodiments of the invention and that various changes and modifications may be made thereto without departing from the spirit and scope of the invention as defined in the appended claims.

1. A pose estimation system comprising:
at least one detector configured to capture a plurality of two-dimensional diffraction patterns caused by diffraction of coherent radiation with different wavelength components at an element; and,
an evaluation device configured to estimate a pose of the element on a basis of the plurality of two-dimensional diffraction patterns.

2. The system of claim 1, wherein the different wavelength components are phase stable relative to one another.

3. The system of claim 2, wherein said evaluation device is configured to use a relative phase angle of the different wavelength components for estimating the pose of the element.

4. The system of claim 3, wherein the system is configured to allow a variable adjustability of a relative phase angle of the different wavelength components.

5. The system of claim 1, wherein said evaluation device is configured to use reference data which depend on a configuration of a diffraction structure of the element, for the pose estimation.

6. The system of claim 1, wherein said evaluation device is configured to carry out a multi-stage evaluation process for the pose estimation, wherein the multi-stage evaluation process includes an initial pose estimate and a refinement of the pose estimate on a basis of the plurality of two-dimensional diffraction patterns.

7. The system of claim 5, wherein said evaluation device is configured to carry out a multi-stage evaluation process for the pose estimation, wherein the multi-stage evaluation process includes an initial pose estimate and a refinement of the pose estimate on a basis of the plurality of two-dimensional diffraction patterns; and, said evaluation device is configured to use the reference data to refine the pose estimate.

8. The system of claim 1 further comprising:
a radiation source or a radiation source arrangement having a plurality of radiation sources for creating the coherent radiation; and,
said radiation source or said radiation source arrangement includes at least one laser, a frequency comb, and an optical parametric oscillator.

9. The system of claim 1, wherein said at least one detector includes a plurality of channels for capturing at least one of the different wavelength components and a synthetic wavelength formed by coherent superposition of the different wavelength components.

10. The system of claim 9, wherein the at least one detector includes a plurality of detectors, wherein surface normals of detector surfaces of said plurality of detectors are at least one of offset and tilted relative to one another.

11. The system of claim 1, wherein said evaluation device is configured to computationally determine six degrees of freedom of the element for the pose estimation.

12. The system of claim 1 further comprising said element, wherein said element includes a diffraction structure with a planar or volumetric arrangement of diffraction structure elements.

13. The system of claim 1, wherein the system includes or is an industrial manufacturing system, an industrial measuring system or a medical system.

14. A pose estimation method comprising:
capturing a plurality of two-dimensional diffraction patterns using at least one detector, wherein the plurality of two-dimensional diffraction patterns are caused by diffraction of coherent radiation with different wavelength components at an element; and,
estimating a pose of the element on a basis of the plurality of two-dimensional diffraction patterns.

15. The method of claim 14, wherein the method is carried out by a system including the at least one detector configured to capture the plurality of two-dimensional diffraction patterns caused by the diffraction of the coherent radiation with the different wavelength components at the element; and, an evaluation device configured to estimate the pose of the element on a basis of the plurality of two-dimensional diffraction patterns.
